(19) United States
(12) Patent Application Publication
(10) Pub. No.: US 2024/0278873 A1
(43) Pub. Date: Aug. 22, 2024

(54) Modification of a Rider's Torque Signal to Optimize the Start-up Behavior of a Pedelec

(71) Applicant: Robert Bosch GmbH, Stuttgart (DE)

(72) Inventors: Joseph Reck, Weil Im Schoenbuch (DE); Daniel Baumgaertner, Neustetten (DE); Merlin Martin Manewald, Reutlingen (DE); Michael Zegowitz, Rottenburg Am Neckar (DE)

(21) Appl. No.: 18/431,385

(22) Filed: Feb. 2, 2024

(30) Foreign Application Priority Data
Feb. 17, 2023 (DE) 10 2023 201 380.0

(51) Int. Cl. B62M 6/50

(52) U.S. Cl. CPC B62M 6/50

(57) ABSTRACT

A control device of a drive of an electric bicycle is disclosed. The control device is designed to (i) receive and/or retrieve a rider's input torque applied by a rider of the electric bicycle, (ii) determine an output torque based on the rider's input torque in a first value range of the rider's input torque according to a first rule, in a second value range of the rider's input torque according to a second rule and in a third value range of the rider's input torque according to a third rule, (iii) determine a supporting torque based on the output torque, and (iv) control the drive in accordance with the supporting torque. The second value range directly adjoins the first value range and the third value range. The first rule and the second rule and the third rule are different from one another. And the second rule is a continuous function with the rider's input torque as input parameter.

This application claims priority under 35 U.S.C. § 119 to patent application no. DE 10 2023 201 380.0, filed on Feb. 17, 2023 in Germany, the disclosure of which is incorporated herein by reference in its entirety.

The present disclosure relates to a method for optimizing the rider's torque of a pedelec.

### BACKGROUND

Electric bicycles support the rider of an electric bicycle by applying a supporting torque to the drive of the electric bicycle. First, the rider's torque applied to the pedals by the rider is determined. The supporting torque is determined by the rider's torque and a support factor.

The start-up situation is critical here. In the start-up situation, no supporting torque is initially provided despite the rider's torque being applied. The supporting torque can also be prevented by other conditions. This makes it easier for the rider to mount the bicycle in a controlled manner. When a threshold value of the rider's torque is reached and any other conditions are met, the supporting torque is applied immediately. The supporting torque results from the above calculation.

Document EP 3053 820 A1 shows an electric bicycle with a time-dependent increase in the torque supporting the rider in a start-up situation. Document EP 273 630 B1 describes an electric bicycle with a start-up detection system, wherein the torque supporting the rider is switched on when a defined speed is exceeded. Document WO2020/002687 describes an electric bicycle with a start-up detection system, wherein a counter torque is provided to the rider of the electric bicycle during the start-up situation. This simulates the resistance and behavior of a mechanical bicycle without support.

### SUMMARY

The control device according to the disclosure of a drive of an electric bicycle allows a more comfortable increase of the supporting torque for a rider and enables a safe transition from a state without support of the rider to a state with support of the rider of the bicycle.

The control device is designed to receive and/or retrieve a rider's input torque applied by a rider of the electric bicycle, to determine an output torque based on the rider input torque in a first value range of the rider's input torque according to a first rule, in a second value range of the rider's input torque according to a second rule and in a third value range of the rider's input torque according to a third rule, and to determine a supporting torque based on the output torque. For example, to determine the supporting torque, a signal representing the output torque is low-pass filtered and an additional factor is applied. The actual determination of the supporting torque depends in particular on the specific design and/or layout of the drive and is generally known. Since the specific implementation of this determination is not relevant to the present disclosure, it will not be discussed in detail.

The control device is designed to control the drive according to the supporting torque. The second value range immediately follows the first value range and the third value range. The first rule and the second rule and the third rule are different from each other. The second rule is a continuous function with the rider's input torque as the input parameter.

This allows the output torque and thus the supporting torque that supports the rider to be adjusted depending on the rider's input torque. By means of the subsequent first value range, second value range and third value range, a transition between two states of the rider's support is mapped seamlessly. Due to the different rules, the different states of the rider's support are represented by the supporting torque based on the output torque. As the second rule is a continuous function, an abrupt transition between two states of rider's support is prevented. This improves the bicycle's controllability for the rider in a start-up situation. This reduces the risk of accidents and improves driving comfort. The steady course of the output torque resulting from the second rule allows a more comfortable transition for the rider between two states of support, independent of the determination of the supporting torque on the basis of the rider's output torque

Preferred embodiments of the control device are set forth below.

Preferably, a first output torque according to the first rule, a second output torque according to the second rule and a third output torque according to the third rule follow one another continuously. This avoids jumps in the course of the output torque in the transition between the first value range, the second value range and the third value range. This improves the bicycle's controllability for the rider, reduces the risk of accidents and improves the rider's comfort.

Particularly preferably, the first rule assigns a first output torque value of zero to the driving input torque in the first value range. The first value range thus represents a state in the start-up situation in which the rider is not supported by an output torque. This allows the rider to mount the bicycle without being disturbed and without having to worry about the bicycle accelerating uncontrollably. This increases the bicycle's controllability, improves riding comfort and reduces the rider's risk of accidents when mounting the bicycle.

Advantageously, the second rule is a polynomial function of a higher degree, in particular a polynomial function of the third degree. The polynomial function can also be used to map a complex rule in a function. This makes it possible to achieve the desired properties of the function simply by adjusting the polynomial function. In particular, the third-degree polynomial function can be used to achieve a logistic course of the output torque in the second value range. The course of a third-degree polynomial function in particular is perceived as pleasant by the rider compared to second-degree or first-degree polynomial functions. Polynomial functions with a degree higher than the third degree also allow for a pleasant course of the output torque, but differ slightly in the rider's perception from the course of the output torque according to the third degree polynomial function and represent a more complex calculation. Particularly in conjunction with a continuous transition between the first output torque, the second output torque and the third output torque, the course of the second output torque using a third-degree polynomial function represents a particularly pleasant course. This results from the course of the second output torque, which has a slight rate of change of the second output torque near the transition to the first output torque and the third output torque.

It is particularly advantageous for the third rule to be a linear function with the rider's input torque as an input parameter, in particular a linear function with a gradient. The third value range represents the regular support of the rider away from a start-up situation. The linear function provides predictable support for the rider through the supporting torque based on the third output torque. This allows the rider to control the bicycle well in the third value range. This results in improved driving comfort and a reduced risk of accidents.

Preferably, a lower limit value of the second value range is 5 Nm and an upper limit value of the second value range is 10 Nm. Consequently, the first value range has an upper limit value of 5 Nm and the third value range has a lower limit value of 10 Nm. These limit values of the second value range are perceived by the rider as particularly pleasant for a transition between a state with little or no support, the first value range, to a state with support, the third value range. The lower limit value and the upper limit value can be adjusted depending on the accuracy of the measurement of the rider's input torque of the underlying sensor.

Particularly preferably, the second rider's output torque at the upper limit value of the second value range and the third rider's output torque at a lower limit value of the third value range have the same gradient. Consequently, there is no kink in the output torque course at the transition between the second output torque and the third output torque. This prevents the support from behaving unexpectedly for the rider and improves the rider's ability to control the bicycle. This reduces the risk of accidents and improves driving comfort for the rider.

Advantageously, the first rider's output torque at an upper limit value of the first value range and the second rider's output torque at the lower limit value of the second value range have the same gradient. Consequently, there is no kink in the output torque course at the transition between the first output torque and the second output torque. This prevents the support from behaving unexpectedly for the rider and improves the rider's ability to control the bicycle. This reduces the risk of accidents and improves driving comfort for the rider.

It is particularly advantageous to calculate the rider's output torque based on the rider's input torque in a fourth value range according to a fourth rule if the rider's input torque falls below the lower limit value of the third value range. The fourth value range follows on from the third value range. The fourth rule and the second rule are different from each other. This makes it possible to differentiate between support to the rider by the supporting torque based on the initial torque, depending on whether the rider is in a start-up situation or whether the rider is already driving. This allows the rider to reduce the rider's input torque for a short time without immediately losing support.

Preferably, the fourth rule also has a polynomial function of a higher degree. In this case, the polynomial function only starts at a rider's torque that is lower than the upper limit value of the second value range. This results in a hysteresis of the output torque over the input torque. This is perceived as particularly pleasant by the rider.

Particularly preferably, the fourth rule can vary in time. Over a defined period of time, in particular a period of time in which the bicycle is not in a start-up situation, the fourth rule can approximate the first rule and/or the second rule of any other function, in particular a linear function, for the first value range and/or the second value range and/or the third value range. By adapting the fourth rule, the course of the output torque resulting from the fourth rule is adapted to the rider's expectation. The rider assumes a linear decrease in the supporting torque based on the rider's output torque with increasing time distance from a start-up situation. The fourth rule thus adapts to the user's changing expectations over time. The user perceives such behavior as more intuitive than a fixed fourth rule over time.

The disclosure further comprises a bicycle. The bicycle comprises an electric drive for driving the bicycle, a sensor for detecting a rider's input torque applied by a rider of the bicycle, and a control device according to one of the preceding embodiments. The control device is designed to control the drive and to receive signals from the sensor. This allows a bicycle with the advantages of the previous embodiments.

### BRIEF DESCRIPTION OF THE DRAWINGS

Exemplary embodiments of the disclosure are described in detail hereinafter with reference to the accompanying drawings. In the drawings:

FIG. 1 is a schematic representation of a bicycle with a control device according to an exemplary embodiment of the disclosure, and

FIG. 2 is a schematic representation of the course of the output torque over the rider's torque according to a first embodiment of the disclosure.

### DETAILED DESCRIPTION

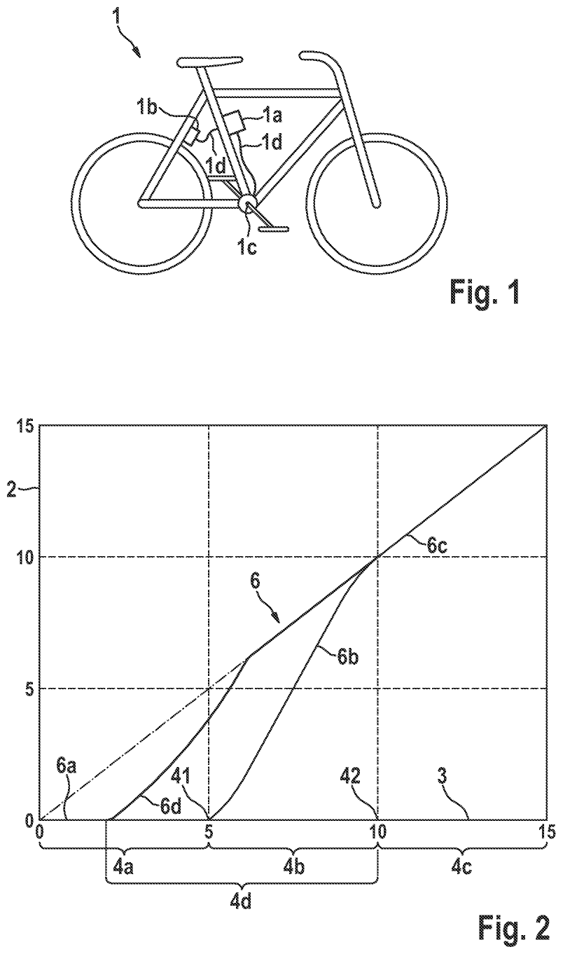

FIG. 1 shows a schematic representation of a bicycle 1 with a control device 1a according to an exemplary embodiment of the disclosure.

The bicycle 1 comprises an electric drive 1c for driving the bicycle 1, a sensor 1b for determining a rider's input torque 3 applied by a rider of the bicycle 1, and a control device 1a according to a first exemplary embodiment. The sensor 1b is arranged, for example, in a pedal shaft of the bicycle 1. The control device 1a is designed to control the drive 1c and to receive signals from the sensor 1b. This allows a bicycle 1 with the advantages of the control device 1a mentioned below in FIG. 2. For this purpose, the control device 1a is connected to the sensor 1b and the drive 1c by means of lines 1d.

FIG. 2 shows a schematic representation of the course of the output torque 6 over the rider's torque 3 according to a first embodiment of the disclosure. The ordinate 2 indicates an output torque 6.

The control device 1a is designed to receive and/or retrieve a rider's input torque 3 applied by a rider of the electric bicycle 1, to determine an output torque 6 based on the rider's input torque 3 in a first value range 4a of the rider's input torque 3 according to a first rule, in a second value range 4b of the rider's input torque 3 according to a second rule and in a third value range 4c of the rider's input torque 3 according to a third rule and to determine a supporting torque based on the output torque 6. The control device 1a is designed to control the drive in accordance with the supporting torque. The second value range 4b immediately follows the first value range 4a and the third value range 4c. The first rule and the second rule and the third rule are different from each other. The second rule is a continuous function with the rider's input torque 3 as the input parameter.

This allows the output torque 6, on the basis of which the supporting torque of the drive is calculated, to be adjusted as a function of the rider's input torque 3. By means of the subsequent first value range 4a, second value range 4b and third value range 4c, a transition between two states of support for the rider is mapped without gaps. Due to the different rules, the different states of the rider's support are represented by the supporting torque based on the output torque 6. As the second rule is a continuous function, an abrupt transition between two states of rider's support is prevented. This improves the controllability of the bicycle 1 for the rider in a start-up situation. This reduces the risk of accidents and improves driving comfort. The steady course of the output torque 6 resulting from the second rule allows a more comfortable transition for the rider between two states of support.

A first output torque 6a according to the first rule, a second output torque 6b according to the second rule and a third output torque 6c according to the third rule follow one another continuously. This avoids jumps in the course of the output torque 6 in the transition between the first value range 4a, the second value range 4b and the third value range 4c. This improves the controllability of the bicycle 1 for the rider, reduces the risk of accidents and improves riding comfort for the rider regardless of the determination of the supporting torque based on the output torque.

The first rule assigns a first output torque 6a with the value zero to the driving input torque in the first value range 4a. The first value range 4a thus represents a state in the start-up situation in which the rider is not supported by a supporting torque based on the initial torque 6. This allows the rider to mount the bicycle 1 without being disturbed and without fear of uncontrolled acceleration of the bicycle 1. This increases the controllability of the bicycle 1 and improves riding comfort and reduces the risk of accidents for the rider when mounting the bicycle 1.

The second rule is a polynomial function of a higher degree, in particular a polynomial function of the third degree. The polynomial function can also be used to map a complex rule in a function. This makes it possible to achieve the desired properties of the function simply by adjusting the polynomial function. In particular, the third-degree polynomial function can be used to achieve a logistic course of the output torque 6 in the second value range 4b. The course of a third-degree polynomial function in particular is perceived as pleasant by the rider compared to second-degree or first-degree polynomial functions. Polynomial functions with a degree higher than the third degree also allow a pleasant course of the output torque 6, but differ slightly from the course of the output torque 6 in the rider's perception and represent a more complex calculation. Particularly in conjunction with a continuous transition between the first output torque 6a, the second output torque 6 and the third output torque 6, the course of the second output torque 6b using a third-degree polynomial function represents a particularly pleasant course. This results from the course of the second output torque 6b, which has a slight rate of change of the second output torque 6b near the transition to the first output torque 6a and the third output torque 6.

The third rule is a linear function with the rider's input torque 3 as the input parameter, in particular a linear function with a gradient. The third value range represents the regular support of the rider away from a start-up situation. The linear function provides predictable support for the rider through the third output torque 6. This allows good controllability of the bicycle 1 by the rider in the third value range 4c. This results in improved driving comfort and a reduced risk of accidents.

The lower limit value 41 of the second value range 4b is 5 Nm and an upper limit value 42 of the second value range 4b is 10 Nm. Consequently, the first value range 4a has an upper limit value 41 of 5 Nm and the third value range 4c has a lower limit value 42 of 10 Nm. These limit values 41, 42 of the second value range 4b are perceived by the rider as particularly pleasant for a transition between a state with little or no support, the first value range 4a, to a state with support, the third value range 4c. The lower limit value 41 and the upper limit value 42 can be adjusted depending on the accuracy of the sensor on which the measurement of the rider's input torque is based.

The second output torque 6 has the same gradient at the upper limit value 42 of the second value range 4b and the third output torque 6 has the same gradient at a lower limit value 42 of the third value range 4c. Consequently, there is no kink in the course of the output torque 6 at the transition between the second output torque 6 and the third output torque 6. This prevents unexpected behavior of the support for the rider and improves the controllability of the bicycle 1 by the rider. This reduces the risk of accidents and improves driving comfort for the rider.

The first output torque 6 has the same gradient at an upper limit value 41 of the first value range 4a and the second output torque 6 has the same gradient at the lower limit value 41 of the second value range 4b. Consequently, there is no kink in the course of the output torque 6 at the transition between the first output torque 6a and the second output torque 6. This prevents unexpected behavior of the support for the rider and improves the controllability of the bicycle 1 by the rider. This reduces the risk of accidents and improves driving comfort for the rider.

The output torque 6 is calculated based on the rider's input torque 3 in a fourth value range 4d according to a fourth rule if the rider's input torque 3 falls below the lower limit value 42 of the third value range 4c. The fourth value range 4d follows on from the third value range 4c. The fourth rule and the second rule are different from each other. This allows the rider to be supported by the supporting torque based on the output torque 6 depending on whether the rider is in a start-up situation or whether the rider is already driving. This allows the rider to temporarily reduce a rider's torque 3 without immediately losing support.

The fourth rule is also a polynomial function of higher degree. Here, the polynomial function only starts at a rider's torque 3 that is lower than the upper limit 42 of the second value range 4b. This results in a hysteresis of the output torque 6 over the input torque. This is perceived as particularly pleasant by the rider.

Particularly preferably, the fourth rule can vary in time. Over a defined period of time, in particular a period of time in which the bicycle (1) is not in a start-up situation, the fourth rule can approximate the first rule and/or the second rule of any other function, in particular a linear function, for the first value range 4a and/or the second value range 4b and/or the third value range 4c. By adapting the fourth rule, the course of the output torque 6 resulting from the fourth rule is adapted to the rider's expectation. The rider assumes a linear decrease in the supporting torque based on the initial torque 6 with increasing time distance from a start-up situation. The fourth rule thus adapts to the user's changing expectations over time. The user perceives such behavior as more intuitive than a fixed fourth rule over time.

What is claimed is:

1. A control device of a drive of an electric bicycle, wherein the control device is designed to:
receive and/or retrieve a rider's input torque applied by a rider of the electric bicycle;
determine an output torque based on the rider's input torque (i) in a first value range of the rider's input torque according to a first rule, (ii) in a second value range of the rider's input torque according to a second rule, and (iii) in a third value range of the rider's input torque according to a third rule;
determine a supporting torque based on the output torque; and
control the drive according to the supporting torque,
wherein the second value range directly adjoins the first value range and the third value range,
wherein the first rule and the second rule and the third rule are different from each other, and
wherein the second rule is a continuous function with the rider's input torque as the input parameter.

2. The control device according to claim 1, wherein a first output torque according to the first rule, a second output torque according to the second rule and a third output torque according to the third rule follow one another continuously.

3. The control device according to claim 1, wherein the first rule assigns a first output torque with the value zero to the rider's input torque in the first value range.

4. The control device according to claim 1, wherein the second rule is a polynomial function of higher degree.

5. The control device according to claim 1, wherein the third rule is a linear function with the rider's input torque as input parameter.

6. The control device according to claim 1, wherein a lower limit value of the second value range is 5 Nm and an upper limit value of the second value range is 10 Nm.

7. The control device according to claim 1, wherein the second output torque at the upper limit value of the second value range and the third output torque at a lower limit value of the third value range have the same gradient.

8. The control device according to claim 1, wherein the first output torque at an upper limit value of the first value range and the second output torque at the lower limit value of the second value range have the same gradient.

9. The control device according to claim 1, wherein:
if the rider's input torque falls below the lower limit value of the third value range, the output torque is calculated based on the rider's input torque in a fourth value range according to a fourth rule,
the fourth value range adjoins the third value range, and
the fourth rule and the second rule are different.

10. A bicycle, comprising:
an electric drive configured to drive the bicycle;
a sensor configured to detect a rider's input torque applied by a rider of the bicycle; and
a control device according to claim 1,
wherein the control device is designed to control the drive and to receive signals from the sensor.

11. The control device according to claim 4, wherein the second rule is a polynomial function of third degree.

12. The control device according to claim 1, wherein the third rule is a linear function with a gradient.
